(19) United States
(12) Patent Application Publication
(10) Pub. No.: US 2023/0322180 A1
(43) Pub. Date: Oct. 12, 2023

(54) COMPRESSED PROPELLANT ELEMENT, METHOD OF MANUFACTURE THEREOF AND GAS GENERATOR COMPRISING PROPELLANT ELEMENT

(71) Applicant: ZF Airbag Germany GmbH, Aschau a. Inn (DE)

(72) Inventors: Sebastian WIENHOLD, Anzing (DE); Michael KÖNIG, Waldkraiburg (DE)

(21) Appl. No.: 18/295,309

(22) Filed: Apr. 4, 2023

(30) Foreign Application Priority Data
Apr. 6, 2022 (DE) 10 2022 108 291.1

(51) Int. Cl. B60R 21/264; C06D 5/06

(52) U.S. Cl. CPC B60R 21/2644; C06D 5/06

(57) ABSTRACT

The invention relates to a propellant element for a gas generator for use in a safety device in the form of a coated pellet (24), wherein the coated pellet (24) comprises a core (20) made of a first pyrotechnical material (46) and a coating (22) made of a second pyrotechnical material (48) and enveloping the core (20), wherein the first pyrotechnical material (48) differs from the second pyrotechnical material (48) and wherein the core (20) includes an edge portion (26) projecting in the radial direction which extends through the coating (22) up to an outer contour (28) of the coated pellet (24), wherein the edge portion (26) is formed along a circumferential direction of the coated pellet (24) and has a smaller expansion than the core (20) in the axial direction of the coated pellet (24).

The invention relates to a propellant element for a gas generator for use in a safety device as well as to a method of manufacturing the propellant element.

Propellant elements for gas generators are known from prior art. In order to protect vehicle occupants during an accident, different safety devices are provided in a vehicle. Such a safety device can be, for example, an airbag module equipped with a gas generator. In the case of an imminent collision of the vehicle with another object, the gas generator releases compressed gas that deploys an airbag out of the airbag module, which results in the vehicle occupants being restrained.

Gas generators serve for generating a compressed gas and are known in various embodiments. Basically, gas generators make use of a propellant element that is disposed inside the gas generator and, after activation by an electrical igniter, enters into an exothermal reaction resulting in the compressed gas being released in the airbag.

Propellant elements are usually provided in the form of pellets which may be manufactured in different ways. As a rule, those pellets have a multi-component structure. For example, propellant elements in the form of pellets are known which are made up of two or more pyrotechnical components. The integration of different pyrotechnical components in one pellet serves to specifically influence a burning characteristic of the propellant element. By optimizing the burning characteristic, inter alia improved inflation behavior of the airbag can be achieved.

In the following, the term burning characteristic means a number of properties which a fuel pellet for a gas generator exhibits in the case of operation, viz. during burning. Burning characteristics are understood to be, for example, the burning rate, the burning velocity, the burning rate on the surface, the gas yield, the self-ignition temperature, the ignitability, the over-ignitability, the pressure exponents and the general (degressive or progressive) burning behavior.

The prior art discloses different options of influencing the burning characteristic of the propellant element.

From DE 097 690A, a method of producing a powder is known the constituents of which are selected so that the combustion of the powder is performed from outside to inside with an increasing velocity. For this purpose, the powder is composed of plural sheets rolled together, the respective sheets having burning characteristics different from each other.

DE 39 33 554 C1 describes a coated pellet for an airbag gas generator, the suggested pellet having a core which is provided with an inert cover selected from a group consisting of borates, boron oxides, aluminate aluminum oxides, silicates and silicon dioxide.

Another coated pellet for a gas generator is disclosed in DE 10 2012 024 799 A1. There is suggested a propellant element in the form of a pellet which has a core made of pyrotechnical material, the core being surrounded at least partially by a sheath of a material retarding the burning of the core.

JP 2001-278 690 A discloses propellant elements of various pellet shapes for use in gas generators, the pellets being made of first and second pyrotechnical materials which are laminated to each other. The first pyrotechnical material differs from the second pyrotechnical material by the burning rate. Primarily, multi-layer pellets which show a multi-layer structure made of the first and second pyrotechnical materials are disclosed in this publication.

In order to ensure optimum burning characteristic, endeavors are made to adapt the properties of the propellant elements as required.

Therefore, it is the object of the invention to provide a propellant element that is easy to manufacture and has a defined burning characteristic.

The object is achieved, according to the invention, by a propellant element in the form of a coated pellet according to claim 1.

Advantageous embodiments of the propellant element according to the invention are stated in the subclaims the features of which can optionally be combined with one another.

In accordance with the invention, the object is achieved by a propellant element for a gas generator for use in a safety device in the form of a coated pellet. The coated pellet comprises a core made of a first pyrotechnical material and a coating enveloping the core made of a second pyrotechnical material. The first pyrotechnical material is different from the second pyrotechnical material. The core has an edge portion projecting in the radial direction which extends through the coating up to an outer contour of the coated pellet. The edge portion is formed along a circumferential direction of the coated pellet and, in the axial direction of the coated pellet, has a smaller extension than the core.

The invention is based on the fundamental idea to provide a propellant element in the form of a coated pellet, each of the core and the coating being made of a different pyrotechnical material. In the coating, an opening in the form of a gap is provided which connects the core via the edge portion to the outer contour of the coated pellet. In this way, merely part of the core can be exposed toward the environment without making the complete core accessible. This is particularly achieved by the edge portion having a smaller extension than the core in the axial direction of the coated pellet. Therefore, the presence of an edge portion ensures that although the burning of the core takes place in parallel to the burning of the coating, it is nevertheless retarded by the geometrical design of the pellet, thereby preventing undesired degressive burning of the pellet.

In addition, the ignitability of the coated pellet according to the invention can be selectively adjusted. This can be performed by selecting the axial expansion of the gap, which results in the accessibility of the core being varied in the form of the edge portion. When a larger gap is selected, more edge portion and, thus, a larger part of the core can be made accessible to the ignition, while with a small axial expansion of the gap the reverse effect will occur and an ignitability of the core will be reduced. This advantageous control of the properties is not restricted to the afore-mentioned example of the ignitability, but is generally applicable to further burning characteristics such as the degressivity of the burning. The coated pellet suggested here thus can be understood to be a hybrid form between the known coated pellets and multi-layer pellets.

At a lower self-ignition temperature of the first pyrotechnical material also an improved pre-ignition function is possible by the exposed land.

As a consequence, the geometric design of the suggested coated pellet allows to achieve improved control of the burning characteristics.

Basically, the shape of the coated pellet according to the invention is not restricted and all shapes known from prior art can be used as long as the afore-mentioned conditions are fulfilled.

Advantageously, the coated pellet has a cylindrical shape. Such cylindrical pellet may have a pellet upper side and a pellet lower side. Between the pellet upper side and the pellet lower side, there may be arranged a land portion extending as a strip-shaped delimiting ring around the pellet and delimiting the radial extension of the core. In the case of compression, the shape of the land portion is defined by a matrix wall. The height of the land portion may be selected as desired and delimits the axial expansion of the edge portion of the core. However, there can also be provided two lands which delimit the axial expansion of the edge portion of the core on both sides. The pellet upper side and a pellet lower side may have a bulge or may be provided with facets. In the case of a bulged pellet, the pellet has a bi-convex shape. The pellet upper and lower sides specifically form spherical balls. The bulge has a bulge radius which represents the radius of the spherical ball.

A cylindrical pellet of this type offers the technical advantage of allowing cost-efficient manufacture particularly by known compression methods.

As above-described, the pellet according to the invention has a coating. The invention is not restricted in respect of the coating. Basically, the shape of the coating can have any design. In addition, the coating forms the outer contour of the coated pellet except for the edge portion that extends through the same. Therefore, the coating may also comprise the land as well as the pellet upper side and the pellet lower side.

In addition to the shape of the coating, also the layer thickness can be freely selected. Depending on the selection of the layer thickness, the burning characteristic of the pellet can be influenced.

The coating completely envelops the core except the edge portion. The edge portion can be freely positioned relative to the core. For example, the edge portion may be arranged centrally relative to the core or slightly offset against the core. In general, also plural edge portions may be provided. They may extend particularly in parallel to each other or may intersect.

Moreover, also the axial expansion of the edge portion is optional, as long as the axial expansion of the edge portion is smaller than that of the core.

The axial expansion of the edge portion may be, for example, not more than 80%, preferably 60%, of preference 40%, particularly preferred 10%, of the axial expansion of the core.

The edge portion can preferably exhibit an expansion of 100 to 3000 μm, preferably 100 to 800 μm, in the axial direction.

This offers the advantage that the burning characteristic of the pellet can be influenced in response to the axial expansion of the edge portion.

In principle, the invention is not restricted to the core with the edge portion. Therefore, any shape can be selected for the core with the edge portion as long as the afore-mentioned conditions are fulfilled. Advantageously, the core with the edge portion takes a shape that can be produced by means of compression.

One aspect of the invention provides that the core with the edge portion has a T-shaped cross-section.

This offers the advantage that a core with an edge portion shaped in this way can be manufactured in a particularly simple manner.

According to another aspect of the invention, the core with the edge portion is provided to have a wedge-shaped cross-section.

According to another aspect of the invention, the core with the edge portion is shaped convexly, and further preferred, the core with the edge portion is shaped bi-convexly.

An asymmetrically bi-convex shape of the core with the edge portion offers the advantage that, when manufacturing the same by means of compression, a particularly dense compaction can be brought about. As a result, particularly undesired air pockets can be avoided in the compact.

According to another aspect, the edge portion is provided to be formed continuously along a circumferential direction of the coated pellet. In this way, a particularly uniform ignitability can be ensured.

The pellet according to the invention has a core made of a first pyrotechnical material and a coating enveloping the core made of a second pyrotechnical material. Basically, the first pyrotechnical material is not restricted in respect of the second pyrotechnical material, and vice versa. The first pyrotechnical material differs from the second pyrotechnical material by at least one property. The way in which the two pyrotechnical materials are different from each other is arbitrary.

Specifically, the two pyrotechnical materials differ regarding at least one of the following properties: chemical composition, burning rate, burning temperature, gas yield, average grain size, particle distribution, particle morphology, hygroscopicity, self-ignition temperature, ignitability and over-ignitability. The two pyrotechnical materials can also differ by two or more of the afore-mentioned properties. In this way, depending on the selection of the first or second pyrotechnical material, the burning characteristic of the pellet can be adjusted as required.

Advantageously, the first pyrotechnical material has a higher burning rate than the second pyrotechnical material. For example, the first pyrotechnical material may have a burning rate ranging from 20 to 60 mm/s at 20 MPas, and the second pyrotechnical material may have a burning rate ranging from 5 to 30 mm/s at 20 MPas. As a result, degressive burning of the core can be prevented, thereby achieving uniform burning of the coated pellet.

According to another aspect, the first pyrotechnical material has a grain size different from the second pyrotechnical material, the first pyrotechnical material having an average grain size (D50) in a range from 1 to 30 μm and the second pyrotechnical material having an average grain size (D50) in a range from 3 to 100 μm.

According to one aspect of the invention, each of the first and second pyrotechnical materials is provided to comprise at least one fuel and one oxidizing agent.

Generally, the invention is not restricted with respect to the fuel and the oxidizing agent. Any fuel known from prior art and any oxidizing agent can be used which are suitable for constituting a propellant element for a gas generator.

Advantageously, the fuel is selected from the group consisting of guanidinium salts, aluminum, polyvinyl acetate, 1-nitroguanidine, nitrotriazolone, tetrazoles, bi-tetrazoles and nitrocellulose, as well as combinations thereof.

The afore-suggested fuels offer the technical advantage that, when activated, they can generate a large gas volume. Also, a wide range of burning rates can be achieved by said fuels. Depending on the desired burning rate, a different fuel can be selected. In addition, they are commercially available and therefore cost-efficient.

The oxidizing agent is specifically selected from the group consisting of perchlorates, copper oxide, basic copper nitrate, basic copper zinc nitrate, sodium nitrate and potassium nitrate, as well as combinations thereof.

The oxidizing agent serves to increase the burning rate. Depending on the selection of the oxidizing agent, the burning rate of the propellant element therefore can be influenced.

Furthermore, each of the first and second pyrotechnical materials can have at least one further additive selected from the group consisting of a stabilizer, a burning rate modifier, a binder and a compression additive, as well as combinations thereof. By adding one of the afore-mentioned additives, the properties of the propellant element can be varied.

As a burning rate modifier, particularly iron(III) oxide, magnesium oxide, titanium oxide and aluminum oxide can be used.

As a compression additive, particularly amorphous silica, calcium stearate and hydrocarbon-based lubricating oil can be used, preferably lubricating oil on the basis of aliphatic hydrocarbon compounds having 15 to 30 carbon atoms.

As a stabilizer, for example Akardit II (3-methyl-1, 1-diphenylurea) can be used.

As a binder, for example alkyl celluloses, hydroxyalkyl celluloses, carboxymethyl celluloses, cellulose carboxylates, xanthan, hydroxyl-terminated polybutadiene (HTPB) and carboxyl-terminated polybutadiene (CTPB) as well as combinations thereof can be used.

Advantageously, the chemical compositions of the first and second pyrotechnical materials are different from each other.

According to one aspect, the two pyrotechnical materials differ by the selection of at least one of the components such as fuel, oxidizing agent and one additive.

The first and second pyrotechnical materials can also be based on the same components, but can be different as regards the proportions of the components. In this way, also the burning characteristic can be varied. For example, the first pyrotechnical material could have an increased proportion of oxidizing agent, which may result in an increase in the burning rate as compared to the second pyrotechnical material.

According to another aspect of the invention, the first pyrotechnical material comprises the following components:

10 to 95 wt. %, preferably 33 to 66 wt. %, of at least one fuel selected from the group consisting of guanidinium nitrate, aluminum, polyvinyl acetate, nitrotriazolone, 1-nitroguanidine, tetrazoles, bi-tetrazoles and nitrocellulose, as well as combinations thereof;

5 to 90 wt. %, preferably 25 to 85 wt. % of at least one oxidizing agent selected from the group consisting of potassium perchlorate, ammonium perchlorate, perchlorates, copper oxide, basic copper nitrate, basic copper zinc nitrate, sodium nitrate, potassium nitrate and further nitrate salts, as well as combinations thereof, and

0 to 15 wt. %, preferably 0 to 5 wt. %, of further additives selected from the group consisting of iron oxide, magnesium oxide, amorphous silica, hydrophobic silica, calcium stearate, stearate salts, fatty acid salts and lubricating oil, as well as combinations thereof, each based on the total weight of the core,

the proportions of the components (A) to (C) supplementing each other to 100 percent.

According to another aspect, the second pyrotechnical material comprises the following components:

20 to 75 wt. %, preferably 45 to 65 wt. %, of at least one fuel selected from the group consisting of guanidinium nitrate and bi-tetrazole, as well as combinations thereof;

25 to 60 wt. %, preferably 39 to 56 wt. %, of at least one oxidizing agent, selected from the group consisting of ammonium perchlorate, potassium perchlorate, perchlorates, sodium nitrate, copper oxide and basic copper nitrate, basic copper zinc nitrate and further nitrate salts, as well as combinations thereof; and

0 to 15 wt. %, preferably 0 to 5 wt. % of further additives selected from the group consisting of iron oxide, titanium oxide, aluminum oxide and calcium stearate, stearate salts and fatty acid salts, as well as combinations thereof, each based on the total weight of the coating,

the proportions of the components (A) to (C) supplementing each other to 100 percent.

The above-suggested compositions of the first and second pyrotechnical materials are particularly suitable for use in a coated pellet for a gas generator. The composition of the first pyrotechnical material exhibits a quicker burning rate than the composition of the second pyrotechnical material. A pellet containing the afore-mentioned compositions specifically exhibits reduced degressivity of the burning.

The pellet can be provided with an additional coating on at least one of its front sides and/or the shell sides. The additional coating can help achieve further functionalities of the pellet. Accordingly, it is of advantage to arrange the additional coating on one of the front sides, because in this way the edge portion is not concealed by the additional coating. Hence, the accessibility of the core is not impaired.

It is also imaginable, however, that the additional coating envelops the complete pellet, i.e., is arranged, apart from the front sides, also on the shell sides, or that only the shell sides are provided with the additional coating.

The additional coating may particularly comprise a moisture-proof coating. A pellet provided with such additional coating advantageously exhibits higher stability of storage in higher air moisture.

For example, hydrophobic polymers, specifically silicones, polyurethanes, polyesters can be used as moisture-proof coating.

The additional coating may comprise a pre-ignition layer which contains a material promoting ignitability of the pellet.

As a pre-ignition layer, for example a pyrotechnical formulation containing nitrocellulose and/or nitrotriazolone can be used.

In this way, the ignitability of the pellet can be inexpensively increased.

Further, the invention relates to a method of manufacturing a propellant element, the method comprising the following steps of:

providing an extrusion die;

filling the extrusion die with a second pyrotechnical material;

compressing the second pyrotechnical material while forming a coating lower side;

further filling the extrusion die with a first pyrotechnical material;

compressing the first pyrotechnical material while forming the core with an edge portion;

further filling the extrusion die with the second pyrotechnical material of step c); and

completing compressing while forming a coating upper side and while obtaining the propellant element.

The afore-described method enables manufacture of the coated pellet according to the invention using compressing machines. The manufacture of pellets using compressing machines is known and has been applied in the pharmaceutical industry for a long time. Thus, the coated pellet according to the invention and the method of manufacturing the coated pellet are particularly cost-efficient.

In addition, the afore-described method enables the coating to be pressed onto the core. Thus, cost-intensive coating or laminating of the core with the coating can be avoided.

Furthermore, the invention relates to use of an afore-mentioned propellant element as a coated pellet for a safety device in a vehicle, specifically in a gas generator.

### EXAMPLES

In the Tables 1 and 2, concrete compositions for the first and second pyrotechnical materials are indicated.

Table 1 illustrates exemplary compositions for the first pyrotechnical material. Table 2 illustrates exemplary compositions for the second pyrotechnical material.

The given compositions are purely exemplary and are not intended to be interpreted in a limiting meaning.

The first pyrotechnical material may include specifically one of the following propellants.

### Example 1

For the first pyrotechnical material a propellant labeled 1-A can be used. It consists of nitrotriazolone in a proportion from 33 to 37 wt. %, guanidinium nitrate in a proportion from 28 to 32 wt. %, potassium perchlorate in a proportion from 32 to 36 wt. % and C15-C30 lubricating oil in a proportion from 0 to 2 wt. %.

### Example 2

For the first pyrotechnical material a propellant labeled 1-B can be used. It consists of nitrotriazolone in a proportion from 78 to 82 wt. %, guanidinium nitrate in a proportion from 9 to 11 wt. %, potassium perchlorate in a proportion from 9 to 11 wt. % and C15-C30 lubricating oil in a proportion from 0 to 2 wt. %.

### Example 3

For the first pyrotechnical material a propellant labeled 1-C can be used. It consists of polyvinyl acetate in a proportion from 14 to 21 wt. %, potassium perchlorate in a proportion from 75 to 85 wt. %, iron(III) oxide in a proportion from 0 to 3 wt. % and magnesium oxide in a proportion from 0 to 3 wt. %.

### Example 4

For the first pyrotechnical material a propellant labeled 1-D can be used. It consists of polyvinyl acetate in a proportion from 15 to 21 wt. %, potassium perchlorate in a proportion from 74 to 84 wt. %, iron(III) oxide in a proportion from 0 to 3 wt. % and magnesium oxide in a proportion from 0 to 3 wt. %.

### Example 5

For the first pyrotechnical material a propellant labeled 1-E can be used. It consists of polyvinyl acetate in a proportion from 17 to 21 wt. %, potassium perchlorate in a proportion from 74 to 84 wt. %, iron oxide in a proportion from 0 to 3 wt. % and magnesium oxide in a proportion from 0 to 3 wt. %.

### Example 6

For the first pyrotechnical material a propellant labeled 1-F can be used. It consists of 1-nitroguanidine in a proportion from 55 to 50 wt. %, potassium perchlorate in a proportion from 40 to 45 wt. %, copper oxide in a proportion from 1 to 3 wt. %, and amorphous silica in a proportion from 0 to 4 wt. %.

### Example 7

For the first pyrotechnical material a propellant labeled 1-G can be used. It consists of guanidinium nitrate in a proportion from 60 to 62 wt. %, potassium perchlorate in a proportion from 34 to 37 wt. %, copper oxide in a proportion from 1 to 3 wt. % and calcium stearate in a proportion from 0 to 2 wt. %.

It is also conceivable that the first pyrotechnical material comprises a combination of the afore-mentioned propellants.

The second pyrotechnical material may contain specifically one of the following propellants.

### Example 8

For the second pyrotechnical material a propellant labeled 2-A can be used. It consists of guanidinium nitrate in a proportion from 47 to 53 wt. %, basic copper nitrate in a proportion from 42 to 48 wt. %, iron(III) oxide in a proportion from 1 to 3 wt. %, titanium dioxide in a proportion from 1 to 3 wt. % and calcium stearate in a proportion from 0 to 2 wt. %.

### Example 9

The second pyrotechnical material may contain a propellant labeled 2-B. It consists of guanidinium nitrate in a proportion from 43 to 49 wt. %, basic copper nitrate in a proportion from 21 to 27 wt. %, ammonium perchlorate in a proportion from 3 to 5 wt. %, sodium nitrate in a proportion from 2 to 4 wt. %, copper oxide in a proportion from 11 to 15 wt. % and iron(III) oxide in a proportion from 9 to 11 wt. %.

### Example 10

The second pyrotechnical material may contain a propellant labeled 2-C. It consists of guanidinium nitrate in a proportion from 49 to 51 wt. %, potassium perchlorate in a proportion from 2 to 4 wt. %, basic copper nitrate in a proportion from 41 to 44 wt. %, titanium dioxide in a proportion from 0 to 2 wt. %, aluminum oxide in a proportion from 1 to 5 wt. % and calcium stearate in a proportion from 0 to 2 wt. %.

### Example 11

The second pyrotechnical material may contain a propellant labeled 2-D. It consists of guanidinium nitrate in a proportion from 50 to 56 wt. %, basic copper nitrate in a proportion from 44 to 47 wt. %, titanium dioxide in a proportion from 0 to 2 wt. %, aluminum oxide in a proportion from 0 to 3 wt. % and calcium stearate in a proportion from 0 to 2 wt. %

The second pyrotechnical material may also comprise a combination of the afore-mentioned propellants.

In general, the above-suggested propellants of the second pyrotechnical material exhibit a lower burning rate than the propellants of the first pyrotechnical material.

The propellants of the examples 1 go 6 exhibit a burning rate in a range from 24 to 50 mm/s at 20 MPas.

The propellants of the examples 7 to 10 exhibit a burning rate in a range from 15 to 30 mm/s at 20 MPas.

The burning rates were determined by means of bombarding the pyrotechnical materials in a closed test can.

TABLE 1
First pyrotechnical material

| | | | Burning rate | Compressing | Proportion |
|---|---|---|---|---|---|
| Labeling | Fuel | Oxidizing agent | modifier | additive | [wt. %] |
| 1-A | nitrotriazolone | | | | 33-37 |
| | guanidinium nitrate | | | | 28-32 |
| | | potassium perchlorate | | | 32-36 |
| | | | | C15-C30 lubricating oil | 0-2 |
| 1-B | nitrotriazolone | | | | 78-82 |
| | guanidinium nitrate | | | | 9-11 |
| | | potassium perchlorate | | | 9-11 |
| | | | | C15-C30 lubricating oil | 0-2 |
| 1-C | polyvinyl acetate | | | | 14-21 |
| | | potassium perchlorate | | | 75-85 |
| | | | iron(III) oxide | | 0-3 |
| | | | magnesium oxide | | 0-3 |
| 1-D | polyvinyl acetate | | | | 15-21 |
| | | potassium perchlorate | | | 74-84 |
| | | | iron(III) oxide | | 0-3 |
| | | | magnesium oxide | | 0-3 |
| 1-E | polyvinyl acetate | | | | 17-21 |
| | | potassium perchlorate | | | 74-84 |
| | | | iron(III) oxide | | 0-3 |
| | | | magnesium oxide | | 0-3 |
| 1-F | 1-nitroguanidine | | | | 50-55 |
| | | potassium perchlorate | | | 40-45 |
| | | copper oxide | | | 1-3 |
| | | | | silica, amorphous | 0-2 |
| | | | | silica, amorphous | 0-2 |
| 1-G | guanidinium nitrate | | | | 60-62 |
| | | potassium perchlorate | | | 34-37 |
| | | copper oxide | | | 1-3 |
| | | | | calcium stearate | 0-2 |

TABLE 2
Second pyrotechnical material

| | | | Burning rate | Compressing | Proportion |
|---|---|---|---|---|---|
| Labeling | Fuel | Oxidizing agent | modifier | additive | [wt. %] |
| 2-A | guanidinium nitrate | | | | 47-53 |
| | | basic copper nitrate | | | 42-48 |
| | | | iron(III) oxide | | 1-3 |
| | | | titanium dioxide | | 1-3 |
| | | | | calcium stearate | 0-2 |
| 2-B | guanidinium nitrate | | | | 43-49 |
| | | basic copper nitrate | | | 21-27 |
| | | ammonium perchlorate | | | 3-5 |
| | | sodium nitrate | | | 2-4 |
| | | copper oxide | | | 11-15 |
| | | | iron(III) oxide | | 9-11 |
| 2-C | guanidinium nitrate | | | | 49-51 |
| | | potassium perchlorate | | | 2-4 |
| | | basic copper nitrate | | | 41-44 |
| | | | titanium dioxide | | 0-2 |
| | | | aluminum oxide | | 1-3 |
| | | | | calcium stearate | 0-2 |
| 2-D | guanidinium nitrate | | | | 50-56 |
| | | basic copper nitrate | | | 44-47 |
| | | | titanium dioxide | | 0-2 |
| | | | aluminum oxide | | 0-3 |
| | | | | calcium stearate | 0-2 |

In the following, the invention will be described in detail by means of preferred embodiments with reference to the attached drawings, wherein:

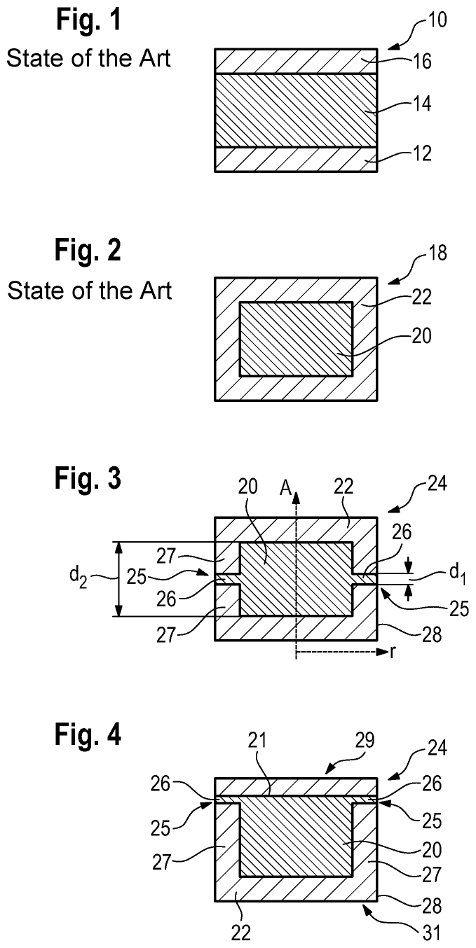

FIG. 1 shows a schematic cross-sectional view of a multi-layer pellet including three layers from prior art for a gas generator;

FIG. 2 shows a schematic cross-sectional view of a coated pellet comprising a completely enveloping coating from prior art for a gas generator;

FIG. 3 shows a schematic cross-sectional view of a coated pellet according to the invention for a gas generator;

FIG. 4 shows a schematic cross-sectional view of a coated pellet according to the invention having a T-shaped core with an edge portion;

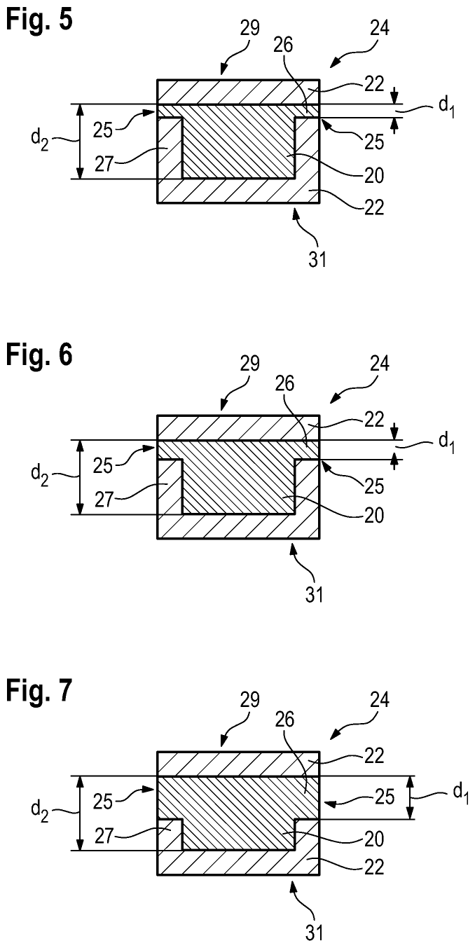

FIG. 5 shows a schematic cross-sectional view of a coated pellet according to the invention having a T-shaped core with an edge portion, the edge portion having a larger axial expansion than in FIG. 4;

FIG. 6 shows a schematic cross-sectional view of a coated pellet according to the invention having a T-shaped core with an edge portion, the edge portion having a larger axial expansion than in FIG. 5;

FIG. 7 shows a schematic cross-sectional view of a coated pellet according to the invention having a T-shaped core with an edge portion, the edge portion having a larger axial expansion than in FIG. 6;

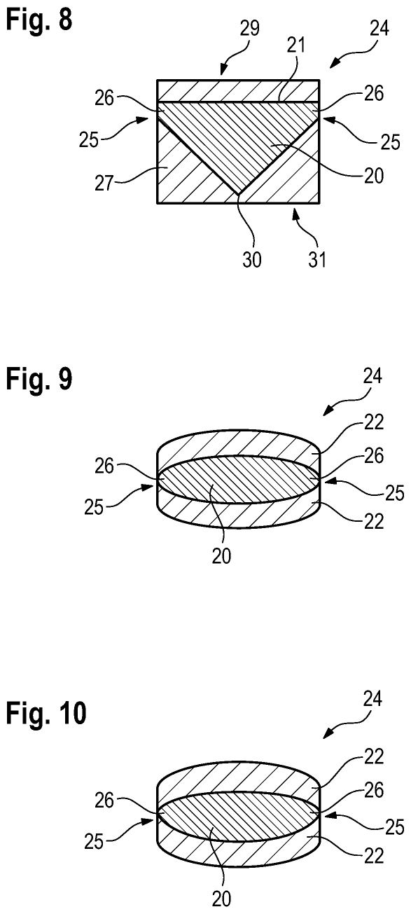

FIG. 8 shows a schematic cross-sectional view of a coated pellet according to the invention having a wedge-shaped core with an edge portion;

FIG. 9 shows a schematic cross-sectional view of a coated pellet according to the invention having a convex core with an edge portion;

FIG. 10 shows a schematic cross-sectional view of a coated pellet according to the invention having an asymmetrically bi-convex core with an edge portion;

FIG. 11 shows the asymmetrically bi-convex coated pellet of FIG. 10 with overlaid radii r₁ and r₂;

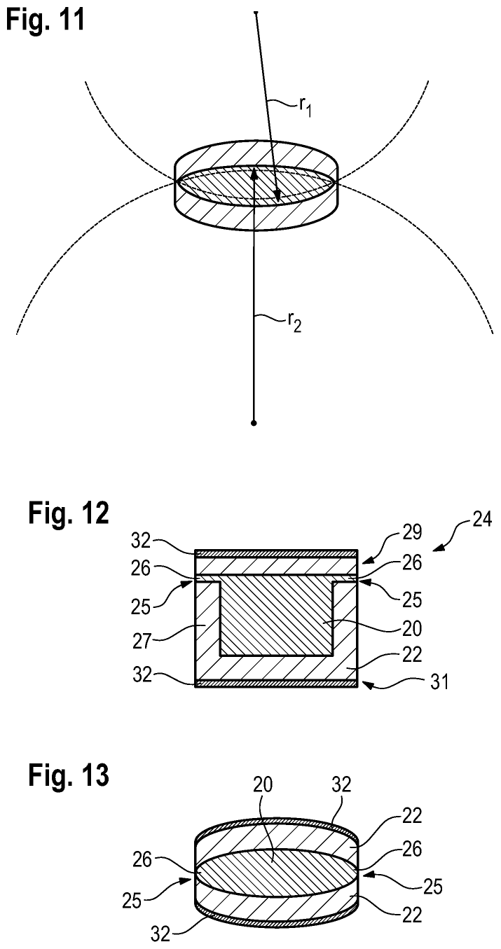

FIG. 12 shows a schematic cross-sectional view of the coated pellet of FIG. 4 comprising additional coatings disposed on the front side;

FIG. 13 shows a schematic cross-sectional view of a coated pellet of FIG. 10 comprising additional coatings disposed on the front side;

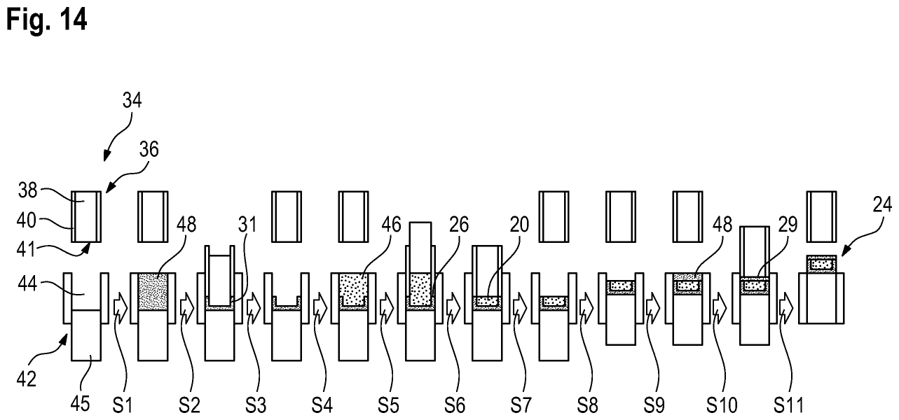

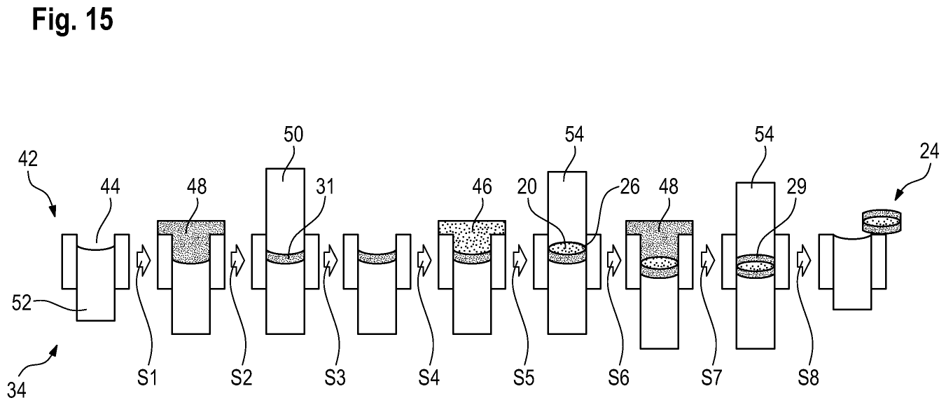

FIG. 14 shows the exemplary sequences of a method of manufacturing a coated pellet according to the invention of FIG. 4;

FIG. 15 shows the sequences of a method of manufacturing a coated pellet according to the invention of FIG. 9 or 10.

FIG. 1 illustrates a schematic cross-sectional view of a multi-layer pellet 10 known from prior art for a gas generator.

The multi-layer pellet 10 is made of three layers. A first layer 12 is pressed onto a core layer 14. A second layer 16 is pressed, in turn, onto a side of the core layer 14 remote from the first layer 12.

As a matter of course, the above-mentioned layers can also be laminated or glued to each other.

Preferably, the first layer 12 and the second layer 16 are made of the same material. Specifically, the first layer 12 and the second layer 16 can be made of the same pyrotechnical material. The core layer 14 usually comprises a pyrotechnical material different from the first and second layers 12, 16.

The layer thicknesses of the three illustrated layers 12, 14, 16 are merely exemplified here. The respective layer thicknesses can be in any ratio. As a rule, the core layer 14 has a higher layer thickness than the first layer 12 and the second layer 16.

FIG. 2 illustrates a known coated pellet 18 from prior art for a gas generator.

The coated pellet is made of a core 20 and a coating 22 enveloping the core. The coating 22 completely envelops the core 20.

The core 20 and the coating 22 are usually made of materials different from each other. For example, the coating may consist of a material retarding the burning of the core.

FIG. 3 illustrates a coated pellet 24 according to the invention comprising a coating 22 which envelops a core 20.

The core 20 includes an edge portion 26 projecting in the radial direction r which extends through the coating 22 to the outer contour 28 of the coated pellet 24. The edge portion 26 is formed integrally with the core 20. In addition, the coated pellet 24 has two land portions 27 extending in the form of strip-shaped delimiting rings around the coated pellet 24 and delimiting the core 20 in its radial expansion. In so doing, the land portion 27 constitutes part of the coating 22 and is formed integrally with the same. The height of the land portions 27 can be selected as desired and delimits the axial expansion of the edge portion 26 of the core 20. As is clearly evident from FIG. 3, the edge portion 26 extends in the radial direction up to the outer contour 28 laterally between the land portions 27, while being delimited in its axial extension by each of respective land portions 27.

Accordingly, the edge portion 26 can be arranged to be axially symmetrical with respect to the core 20. However, it is also imaginable that the edge portion 26 is not arranged to be axially symmetrical. For example, the edge portion 26 may be displaced relative to the core or may be formed around the core like a spindle, or else areas of the edge portion may be offset against each other.

Specifically, the edge portion 26 extends continuously along a circumferential direction of the pellet 24. In other words, the coating 22 includes an ignition gap 25 circumferential around the coated pellet 24 which is filled by an edge portion 26 of the core 20.

The expansion of the edge portion 26 in the radial direction r preferably depends on the layer thickness of the land portions 27. The smaller the layer thickness of the land portions 27 is selected, the smaller can the expansion of the edge portion 26 be selected in the radial direction r.

According to the invention, in an axial direction A of the coated pellet 24, the edge portion 26 has a smaller expansion than the core 20. To be more precise, in the axial direction A of the coated pellet 24, the edge portion 26 has an axial expansion d1 which is smaller than an axial expansion d2 of the core 20 in the axial direction A of the coated pellet 24.

The positioning of the edge portion 26 relative to the core 20 is optional. For example, the edge portion 26 may enclose the core 20 centrally, as is clearly evident from FIG. 3. However, the edge portion 26 may as well be offset against the center of the core 20, as a matter of course.

The core 20 and the edge portion 26 comprise a first pyrotechnical material.

The coating 22 comprises a second pyrotechnical material.

The first and second pyrotechnical materials are different from each other.

Specifically, the two pyrotechnical materials are different regarding at least one of the following properties: chemical composition, burning rate, burning temperature, gas yield, average grain size, particle distribution, particle morphology, hygroscopicity, self-ignition temperature, ignitability and over-ignitability.

The two pyrotechnical materials may also differ by two or more of the afore-mentioned properties.

Advantageously, the first pyrotechnical material has a higher burning rate than the second pyrotechnical material.

Each of the first and second pyrotechnical materials comprises at least one fuel and one oxidizing agent.

Generally, the invention is not restricted in respect of the fuel and the oxidizing agent. Any fuel and any oxidizing agent known from prior art which are suited to form a propellant element for a gas generator can be used.

Of advantage, the fuel is selected from the group consisting of guanidinium salts, aluminum, polyvinyl acetate, 1-nitroguanidine, nitrotriazolone, tetrazoles, bi-tetrazoles and nitrocellulose, as well as combinations thereof.

The oxidizing agent is specifically selected from the group consisting of perchlorates, copper oxide, basic copper nitrate, basic copper zinc nitrate, sodium nitrate, potassium nitrate and further nitrate salts, as well as combinations thereof.

Further, each of the first and second pyrotechnical materials can include at least one further additive selected from the group consisting of stabilizer, burning rate modifier, binder and compressing additive, as well as combinations thereof. By adding one of the afore-mentioned additives, the properties of the propellant element can be varied.

As a burning rate modifier, specifically iron(III) oxide, magnesium oxide, titanium oxide and aluminum oxide can be used.

As a compression additive, specifically amorphous silica, calcium stearate and hydrocarbon-based lubricating oil, preferably lubricating oil based on aliphatic hydrocarbon compounds having 15 to 30 carbon atoms, can be used.

As a stabilizer, for example Akardit II can be used.

As a binder, for example alkyl celluloses, hydroxyalkyl celluloses, carboxymethyl celluloses, cellulose carboxylates, xanthan, HTPB, CTPB, and combinations thereof can be used.

The chemical compositions of the first pyrotechnical material and the second pyrotechnical material are advantageously different from each other.

According to one aspect, the two pyrotechnical materials differ by the selection of at least one of the components such as fuel, oxidizing agent and additive.

The first and second pyrotechnical materials also may be based on the same components, but may differ regarding the proportions of the components.

FIG. 4 illustrates a coated pellet 24 according to the invention comprising a core 20 T-shaped in cross-section with an edge portion 26. For the features and components known from FIG. 3, the same reference numerals are used, and the above explanations are referred to in this respect.

In contrast to FIG. 3, in FIG. 4 the core 20 with the edge portion 26 forms a joint front face 21 opposite to a side of the coating 22 facing the core 20. In addition, the coated pellet 24 shown in FIG. 3 has only one land portion 27.

The edge portion 26 and the core 20 divide the coating 22 into a coating upper side 29 which abut on the front face 21 and forms a pellet upper side of the coated pellet 24 and a coating lower side 31 which is U-shaped in cross-section and comprises a part of the core 20 opposite to the front face 21. The coating lower side 31 forms a pellet lower side of the coated pellet 24. A closer look reveals that the pellet lower side includes a pellet bottom and a land portion 27 extending from the pellet bottom to the edge portion 26. Thus, the land portion 27 delimits the core 20 in the radial direction and delimits the edge portion 26 in the axial direction.

The coating upper side 29 and the coating lower side 31 may have a bulge or may be provided with facets (not shown here). The bulge may result in a bi-convex shape of the coated pellet, for example.

The layer thickness of the coating upper side 29 and the coating lower side 31 is optional. The layer thicknesses of the coating upper side 29 and the coating lower side 31 may be different from or concur with each other.

As described already in the foregoing, the axial expansion d1 of the edge portion 26 may be optionally selected, as long as it is smaller than the axial expansion d2 of the core 20. This fact is illustrated in FIGS. 5 to 7 in which a stepwise larger axial expansion d1 of the edge portion 26 than the expansion of the edge portion 26 represented in FIG. 4 is shown.

The axial expansion of the edge portion 26 shown in FIGS. 5 to 7 results in the ignition gap 25 being increased in the axial direction A, resulting in a larger part of the edge portion 26 being exposed. Thus, also a larger part of the core 20 is exposed. Consequently, the ignitability of the core 20 increases from FIG. 5 to FIG. 7. In this way, the ignitability of the coated pellet 24 can be influenced by varying the ignition gap in the axial direction A.

FIG. 8 illustrates another embodiment of the coated pellet 24 according to the invention. For the features and components known from the previous Figures, the same reference numerals are used and the foregoing explanations are referred to in this respect.

The coated pellet 24 in FIG. 8 has a core 20 with an edge portion 26, the edge portion 26 and the core 20 together taking a wedge shape.

The base of the wedge shape forms the front face 21 which is disposed adjacent to the coating upper side 29.

The wedge shape also has a wedge tip 30 that is embedded in the coating lower side 31.

The opening angle of the wedge tip 30 may be selected at will.

FIG. 9 illustrates another embodiment of the coated pellet 24 according to the invention. For the features and components known from the previous Figures, the same reference numerals are used and the foregoing explanations are referred to in this respect.

The coated pellet 24 shown in FIG. 9 has a core 20 and an edge portion 26 which together are bi-convexly shaped.

In addition, also the coating 22, in particular the coating upper and lower sides 29, 31, take a bi-convex shape.

The core 20 and the coating 22 may have the same radius. This facilitates specifically the manufacture of such coated pellet 24. However, the core 20 and the coating 22 may also have radii which are different from each other.

In this embodiment, the edge portions 26 are formed by the pointed ends of the bi-convex core 20.

FIG. 10 illustrates the coated pellet 24 of FIG. 9, the difference being that the core 20 and the edge portion 26 together take an asymmetrically bi-convex shape.

Thus, also the coating 22 takes an asymmetrically bi-convex shape.

FIG. 11 illustrates the structure of the asymmetrically bi-convex shape of FIG. 10.

The core 20 with the edge portion 26 has two different radii r1 and r2. The radius r1 differs from the radius r2. For example, the radius r2 is larger than the radius r1 as shown in FIG. 11.

FIG. 12 shows the coated pellet 24 according to the invention of FIG. 4, the difference being that an additional coating 32 is provided on both front faces of the coated pellet 24.

The additional coating 32 is disposed so that the edge portion 26 of the coated pellet 24 is not concealed.

The layer thickness of the additional coating 32 is not restricted and can be selected as required.

The additional coating 32 may specifically comprise a moisture proof coating. A coated pellet 24 provided with such additional coating 32 advantageously exhibits higher stability of storage in high air moisture.

As a moisture proof coating, for example hydrophobic polymers, specifically silicones, polyurethanes, polyesters can be used.

The additional coating may comprise a pre-ignition layer which contains a material promoting the ignitability of the pellet.

As a pre-ignition layer, for example a pyrotechnical formulation containing nitrocellulose, nitrotriazolone can be used.

FIG. 13 illustrates a coated pellet 24 according to the invention of FIG. 10, the difference being that an additional coating 32 is disposed on the front faces of the coated pellet 24.

FIG. 14 illustrates a method of manufacturing a coated pellet 24 according to the invention of FIG. 4. Hereinafter, the method shall be explained in detail.

The coated pellet 24 according to the invention is manufactured in a press 34.

The press 34 contains an upper punch 36, an extrusion die 42 and a lower punch 45.

The upper punch 36 and the lower punch 45 are arranged facing each other.

The extrusion die 42 and the lower punch 45 define a receiving chamber 44, specifically a cylindrically shaped or elliptically shaped receiving chamber 44. In addition, the lower punch 45 can be displaced relative to the extrusion die 42.

In particular, the receiving chamber 44 may be a negative to the upper punch 36.

The upper punch 36 is arranged to be displaced toward the extrusion die 42 and to engage in the receiving chamber 44.

Basically, the upper punch 36 takes a cylindrical shape and comprises an inner punch 38 and an outer punch 40.

The outer punch 40 laterally encloses the inner punch 38, the inner punch 38 being slidingly supported within the outer punch 40. Thus, the inner punch 38 can be displaced relative to the outer punch 40. Furthermore, the outer punch 40 with the inner punch 38 forms a joint front face 41 by which the upper punch 36 engages in the receiving chamber 44 of the extrusion die 42 during a compressing operation.

However, it is also conceivable that, for the individual method steps, different upper punches 40 are used which are different from each other as regards the respective extent of displacement of the inner punch 38 relative to the outer punch 40. In this case, the inner punch 38 is formed integrally with the outer punch 40. For example, in each of the method steps S2, S5, S6 and S10 a separate upper punch 40 can be used.

In a first step, the receiving chamber 44 is filled with a second pyrotechnical material 48 (S1).

Subsequently, the upper punch 36 is pressed into the receiving chamber 44 of the extrusion die 42 and the second pyrotechnical material 48 is compacted (S2). In this compressing operation, the inner punch 38 is pushed further into the receiving chamber 44 than the outer punch 40. In this way, the second pyrotechnical material 48 can be formed while obtaining a coating lower side 31. Since the outer punch 40 is pushed into the receiving chamber offset vis-a-vis the inner punch 38, specifically a coating lower side 31 having a U-shaped cross-section is formed. The coating lower side 31 is opened toward the upper punch 36.

Then the upper punch 36 is withdrawn from the extrusion die 42 again (S3) and the completely compressed coating lower side 31 is retained in the extrusion die 42.

After that, the receiving chamber 44 is filled with a first pyrotechnical material 46 (S4).

In the next step, the upper punch 36 is pressed into the receiving chamber 44 again, wherein at first only the outer punch 40 is pressed into the receiving chamber 44 (S5). In this way, an edge portion 26 made of the first pyrotechnical material 46 is pressed onto laterally projecting areas of the coating lower side 31.

Now the inner punch 38 is pressed into the receiving chamber 44 (S6) until it forms a joint front face 41 with the outer punch 40 again. Thus, a core 20 is pressed into the coating lower side 31 opened toward the upper punch 36.

Subsequently, the upper punch 36 is withdrawn from the extrusion die 42 again (S7) while obtaining a compact consisting of the coating lower side 31 which comprises a pre-compacted core 20 with an edge portion 26.

The compact is moved toward the upper punch 36 by the lower punch 45 in the receiving chamber 44 (S8).

Finally, the second pyrotechnical material 48 is filled into the receiving chamber 44 again (S9).

Ultimately, the upper punch 36 is pressed into the receiving chamber 44 again or the extrusion die 42 is moved and, resp., in general, the distance between the upper punch and the extrusion die 42 is reduced so that the second pyrotechnical material 48 is compressed while obtaining the coating upper side 29 and, thus, the finished coated pellet 24 (S10).

In the last step, the upper punch 36 is withdrawn from the receiving chamber 44. In addition, the lower punch 45 is displaced toward the upper punch 36 so far that the receiving chamber 44 is completely occupied by the lower punch 45 (S11). The coated pellet 24 can be removed from the press 34.

FIG. 15 describes the sequences of a method of manufacturing a coated pellet 24 having a bi-convexly, optionally an asymmetrically bi-convexly, shaped core with an edge portion.

In the following, the sequences of said method shall be explained in detail.

At first, the same press 34 is provided as in FIG. 14, the difference being the use of a convex upper punch 50 and a concave upper punch 54. Moreover, in the press 34 a concave lower punch 52 is used.

Convex and concave in this context means that only the respective front faces of the punches 50, 52, 54 have a curvature. For manufacturing a bi-convex coated pellet 24, the curvature of the convex upper punch 50 corresponds to that of the concave lower punch 52. Manufacture of an asymmetrically bi-convexly shaped coated pellet is carried out by using a concave lower punch 52 and a concave upper punch 54 which do not have the same curvature on their front faces.

The front face of the convex upper punch 50 has a curvature with a radius that corresponds to the curvature of the front face of the concave lower punch 52. The concave lower punch 52 is curved so that the convex upper punch 50 can engage in the lower punch, specifically that the convex upper punch 50 can positively engage in the lower punch.

In other words, the front face of the upper punch 50 preferably takes a convex shape which is complementary to a concave shape of the lower punch 52.

In a first step, the receiving chamber 44 is filled with a second pyrotechnical material 48 (S1).

Subsequently, a convex upper punch 50 is pressed into the receiving chamber 44 and the second pyrotechnical material 48 is compacted while obtaining a coating lower side 31 (S2).

Since both the concave lower punch 52 and the convex upper punch 50 are formed complementary on their front faces, also the coating lower side 31 resulting from the pressing is convexly shaped.

The convex upper punch 50 is initially pushed back from the receiving chamber 44 and is removed from the press (S3).

The receiving chamber 44 is filled with a first pyrotechnical material 46 (S4).

In the next step, the first pyrotechnical material 46 is compacted by pushing a concave upper punch 54 into the receiving chamber 44 while obtaining a core 20 with an edge portion 26 (S5).

Since the coating lower side 31 present in the extrusion die 42 predefines a convex shape and the concave upper punch 54 pushed into the receiving chamber 44 from the other side predefines a concave shape, a core 20 with an edge portion 26 taking a bi-convex shape is resulting from said pressing operation.

Optionally, for the foregoing step a concave upper punch 54 can be used which has a curvature deviating from the curvature of the concave lower punch 52. Thus, an asymmetrically bi-convexly shaped core 20 can be pressed.

In the next step, the concave upper punch 54 can be pushed out of the extrusion die 42 again and a second pyrotechnical material 48 can repeatedly be filled into the receiving chamber 44 (S6).

Finally, the second pyrotechnical material 48 can be completely pressed by the concave upper punch 54 or the lower punch is moved, or, resp., in general, the distance between the upper and lower punches is reduced to achieve pre-pressing, while a convexly shaped coating upper side 29 is obtained (S7).

Optionally, for the foregoing step a concave upper punch 54 can be used which has a curvature deviating from the concave lower punch 52. This results in an asymmetrically bi-convexly shaped coated pellet 24.

In the last step, the bi-convexly, optionally asymmetrically bi-convexly, shaped coated pellet 24 can be removed from the extrusion die 42 (S8).

1. A propellant element for a gas generator for use in a safety device in the form of a coated pellet (24), the coated pellet (24) comprising a core (20) made of a first pyrotechnical material (46) and a coating (22) made of a second pyrotechnical material (48) and enveloping the core (20), wherein the first pyrotechnical material (46) is different from the second pyrotechnical material (48), and wherein the core (20) has an edge portion (26) projecting in the radial direction which extends through the coating (22) up to an outer contour (28) of the coated pellet (24), wherein the edge portion (26) is formed along a circumferential direction of the coated pellet (24) and has a smaller expansion than the core (20) in the axial direction of the coated pellet (24).

2. The propellant element according to claim 1, wherein the core (20) with the edge portion (26) has a T-shaped cross-section.

3. The propellant element according to claim 1, wherein the core (20) with the edge portion (26) has a wedge-shaped cross-section.

4. The propellant element according to claim 1, wherein the core (20) with the edge portion (26) is convexly shaped, further preferably that the core (20) with the edge portion (26) is bi-convexly shaped.

5. The propellant element according to claim 1, wherein the core (20) with the edge portion (26) is asymmetrically bi-convexly shaped.

6. The propellant element according to claim 1, wherein the edge portion (26) is formed continuously along a circumferential direction of the coated pellet (24).

7. The propellant element according to claim 1, wherein an axial extension of the edge portion (26) amounts to not more than 80%, preferably 60%, of preference 40%, particularly preferred 10%, of an axial extension of the core (20).

8. The propellant element according to claim 1, wherein the first pyrotechnical material (46) exhibits a higher burning rate than the second pyrotechnical material (48).

9. The propellant element according to claim 1, wherein the first pyrotechnical material (46) exhibits a burning rate in a range from 20 to 60 mm/s at 20 MPas and the second pyrotechnical material (48) exhibits a burning rate in a range from 5 to 30 mm/s at 20 MPas.

10. The propellant element according to claim 1, wherein the first pyrotechnical material (46) comprises the following components:
(A) 10 to 95 wt. %, preferably 33 to 66 wt. %, of at least one fuel selected from the group consisting of guanidinium nitrate, aluminum, polyvinyl acetate, nitrotriazolone, tetrazoles, bi-tetrazoles, nitrocellulose and 1-nitroguanidine, as well as combinations thereof;
(B) 5 to 90 wt. %, preferably 25 to 85 wt. %, of at least one oxidizing agent selected from the group consisting of potassium perchlorate, ammonium perchlorate, perchlorates, copper oxide, basic copper nitrate, basic copper zinc nitrate, sodium nitrate, potassium nitrate and further nitrate salts, as well as combinations thereof, and
(C) 0 to 15 wt. %, preferably 0 to 5 wt. %, of further additives selected from the group consisting of iron oxide, magnesium oxide, amorphous silica, hydrophobic silica, calcium stearate, stearate salts, fatty acid salts and lubricating oil, as well as combinations thereof, each based on the total weight of the core,
wherein the proportions of the components (A) to (C) supplement each other to 100 percent.

11. The propellant element according to claim 1, wherein the second pyrotechnical material (48) comprises the following components:
(A) 20 to 75 wt. %, preferably 45 to 65 wt. %, of at least one fuel selected from the group consisting of guanidinium nitrate, 1-nitroguanidine, tetrazoles and bi-tetrazoles, as well as combinations thereof;
(B) 25 to 60 wt. %, preferably 39 to 56 wt. %, of at least one oxidizing agent selected from the group consisting of ammonium perchlorate, potassium perchlorate, perchlorates, copper oxide, basic copper nitrate, basic copper zinc nitrate, sodium nitrate, potassium nitrate and further nitrate salts, as well as combinations thereof; and
(C) 0 to 15 wt. %, preferably 0 to 5 wt. %, of further additives selected from the group consisting of iron oxide, titanium oxide, aluminum oxide and calcium stearate, stearate salts and fatty acid salts, as well as combinations thereof, each based on the total weight of the receiving element and the closure element,
wherein the proportions of the components (A) to (C) supplement each other to 100 percent.

12. The propellant element according to claim 1, wherein the first pyrotechnical material (46) has a grain size different from a second pyrotechnical material (48), the first pyrotechnical material (46) having an average grain size (D50) in a range from 1 to 30 μm and the second pyrotechnical material (48) having an average grain size (D50) in a range from 3 to 100 μm.

13. The propellant element according to claim 1, wherein the coated pellet (24) is further provided, on at least one of its front faces, with an additional coating (32), the additional coating (32) preferably comprising a material promoting ignitability of the coated pellet (24).

14. A method of manufacturing a propellant element according to claim 1, wherein the method comprises the following steps of:
a) providing an extrusion die;
b) filling the extrusion die with a second pyrotechnical material;
c) compressing the second pyrotechnical material while forming a coating lower side;
d) further filling the extrusion die with a first pyrotechnical material;
e) compressing the first pyrotechnical material while forming the core with an edge portion;
f) further filling the extrusion die with the second pyrotechnical material of step c);
g) completing compression while forming a coating upper side and while obtaining the propellant element.

15. Use of a propellant element according to claim 1 in a safety device in a vehicle, specifically in a gas generator.
